(19) United States
(12) Patent Application Publication
(10) Pub. No.: US 2014/0300111 A1
(43) Pub. Date: Oct. 9, 2014

(54) FENCE THAT USES WIND POWER AND SOLAR PHOTOVOLTAIC POWER TO PRODUCE ELECTRICITY

(71) Applicant: Jonathan David Saitta, Foster City, CA (US)

(72) Inventor: Jonathan David Saitta, Foster City, CA (US)

(21) Appl. No.: 13/441,918

(22) Filed: Apr. 9, 2012

(51) Int. Cl. F03D 9/00

(52) U.S. Cl. CPC F03D 9/003
USPC 290/55

(57) ABSTRACT

A fence that creams electricity using both wind power and solar photovoltaic power. By including wind blades as part of the fence, it turns the axel, which is connected to a generator to produce electricity, At the top of the fence there are solar photovoltaic cells, which produce additional electricity. An inverter converts this DC power into AC power to produce electricity that can be used to power such things as homes or businesses.

### FIELD OF THE INVENTION

This invention relates to using renewable energy sources such as the wind and the sun to turn a fence into one that produces electricity.

### BACKGROUND OF THE INVENTION

Fences date back to early human history to protect themselves, to herd animals, to establish property lines, etc. With one quarter of the world population having no electricity, a fence that produces usable electricity to power homes and businesses can be a useful product to people. In rural areas, this fence delivering energy to homes can eliminate the need for fires to heat or cook food. According to the World Health Organization, over a million people die each year from inhaling smoke from fires made for indoor cooking, to keep people warm or read at night. This inexpensive way to create electricity would help people live a better life as well as save lives.

The Sun produces enough energy in one hour to power the entire earth for a year. Using the solar photovoltaic effect, panels across the top part of the fence generate electricity. An inverter converts the DC power into popular AC power to be used in houses and businesses. As the cost of solar gets lower, this makes the cost of the fence even more cost-effective.

Wind blows throughout the day. When solar is not working during nighttime, the wind blows and generates electricity by turning a turbine generator.

### DESCRIPTION OF THE INVENTION

This invention uses these two renewable energy sources to produce electricity. In rural areas, this can be their only source of power to live their life. In more developed areas, this can be used to eliminate the need for homes and buildings to get their electricity from the utility grid.

Wind power has been extensively used as a proven technology. Solar power is also a proven technology that has been used for decades. However this invention is the first to combine the two renewable technologies into a fence.

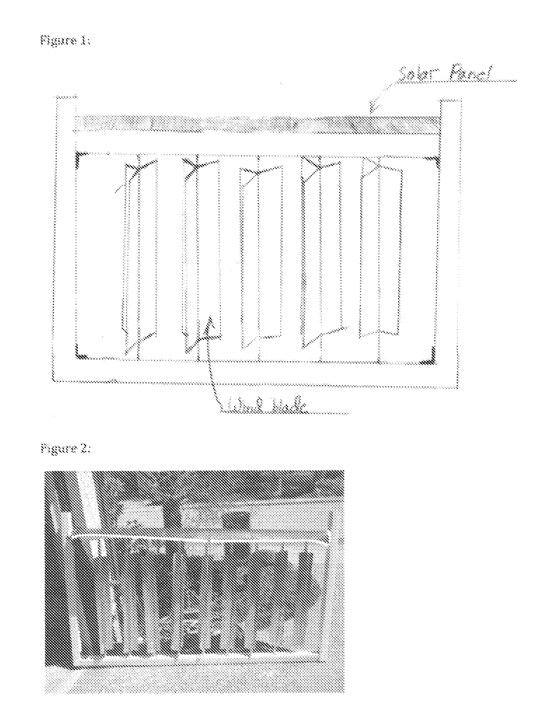

As seen in FIG. 1, this section of the fence shows the wind blades that turn the axel that turns a turbine generator that produces electricity. The solar cells on top captures light and converts it into electricity.

This fence can be used to stretch across highways and power the lights at night along the streets. This fence can be used on a person's home to power their home's electrical needs.

In FIG. 2, a photo of a prototype is displayed. It has solar cells on the top of the fence. This prototype uses thin film solar, but it could have numerous other solar photovoltaic technologies. Anyone that is simply skilled in wind or solar can understand how these components will work to produce electricity for people.

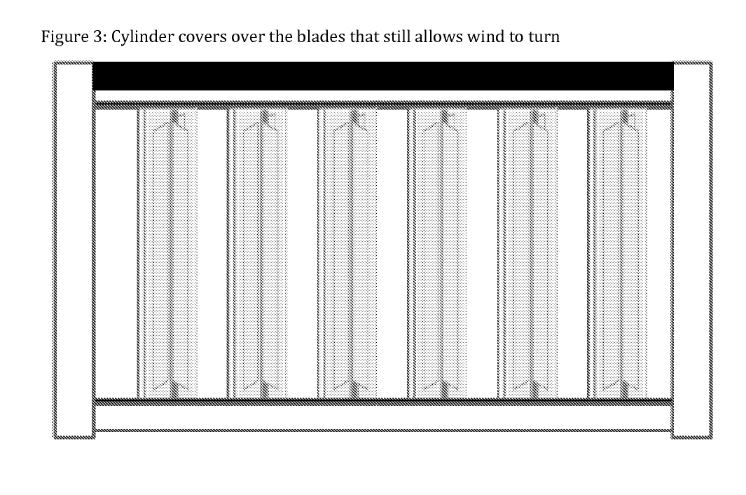

In order to prevent damage to the wind blades as well as to people/animals, an optional cylinder cover can be placed around the wind blade so that wind can enter and turn the axis. (FIG. 3)

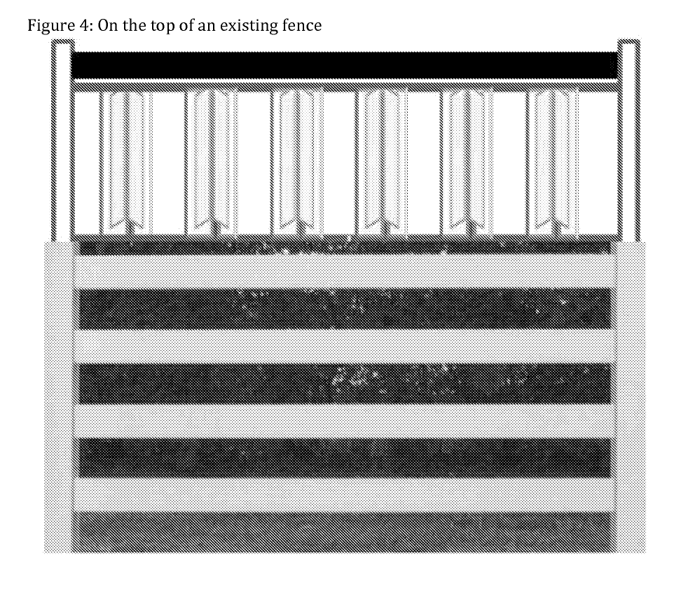

If there is already an existing fence, the invention can become a part of the fence by attaching to the top of it. (FIG. 4)

These fences could stretch across fields, highways, and along the coast. This is a much more attractive solution then giant traditional wind mills and large solar farms.

With a significant part of the world supporting net-metering which enables electricity generated to back-feed into the existing power grid, this invention enables the electricity from the renewable energy fence to be used to efficiently power homes and businesses everywhere.

The invention claimed is:

1. A method of generating electricity with a fence that uses wind and solar energy.

2. A system according to claim 1 wherein a part of the fence uses wind to turn wind blades attached to a generator to produce electricity as well as solar cells that use the photovoltaic effect to produce electricity. This electricity can be used to power the home or business entity
